(19) United States
(12) Patent Application Publication
(10) Pub. No.: US 2022/0408134 A1
(43) Pub. Date: Dec. 22, 2022

(54) A Method and System for Providing Advertisements

(71) Applicant: Nooggi Pte ltd, Singapore (SG)

(72) Inventors: Shu Ching Quek, Singapore (SG); Toi Mien Quek, Singapore (SG)

(21) Appl. No.: 17/628,464

(22) PCT Filed: Jul. 24, 2019
(86) PCT No.: PCT/SG2019/050359

§ 371 Date: Jan. 19, 2022

(51) Int. Cl. H04N 21/2543; G06Q 30/02; H04N 21/81; H04N 21/442; H04N 21/4784; H04N 21/258

(52) U.S. Cl. CPC H04N 21/25435; G06Q 30/0241; H04N 21/812; H04N 21/44204; H04N 21/4784; H04N 21/25875

(57) ABSTRACT

A method is disclosed, the method providing to a device of a user, an advertisement bundle, the advertisement bundle having a runtime and comprising at least one advertisement configured to be played on the device. The method further comprises the steps of detecting that the advertisement bundle has been played to an end of the runtime; and computing a reward value based on the advertisement bundle. The method further comprises the step of automatically transmitting to a subscription server, the reward value and a subscription account number, such that the reward value can be utilized by the subscription server to offset an outstanding subscription payment associated with the subscription account number.

### FIELD OF THE INVENTION

The invention pertains to a method and system for providing advertisements to users. The invention also relates to rewarding users for watching the advertisements by automatically offsetting their subscription payments.

### BACKGROUND

In a video sharing platform like YouTube, access to its platform is free to users because the platform owners make their revenue via advertising. However, the drawback is that a user, in today's highly connected digital world, is typically exposed to between 4000 to 10000 advertisements daily. It has gotten to the point that most users tend to ignore advertisements which are force-fed to them. Users will either just ignore pop up advertisements, or will go about their own tasks till the advertisements have finished and content is resumed. Therefore, there exists a need to incentivize users to watch advertisements by providing some form of benefit or incentive.

There should also be some way of ensuring the viewer actually watches the advertisements. Known techniques include preventing viewers from “fast-forwarding” the advertisements or periodically displaying a button for the viewer to click. However such methods can appear high-handed, distracting and even intrusive. It is also difficult to justify effectiveness of the advertisements which may result in alienating brand and advertising agencies. Therefore, there needs to be a novel approach to keep the viewer's attention.

Thus, what is required is a novel method which addresses the above problems by providing a platform which allows users to watch advertisements at their convenience, and as a reward of having watched the advertisements, automatically offset the subscription payments. Another object of the invention is to integrate ad-challenges into the advertisements to keep the users engaged. A further object of the invention is to customize user-specific advertisement bundles and ad-challenges based on the emotional analytics data gathered from the user watching the advertisements and interacting with the ad-challenges. Furthermore, other desirable features and characteristics will become apparent from the subsequent detailed description and the appended claims, taken in conjunction with the accompanying drawings and this background of the disclosure.

### SUMMARY OF INVENTION

According to a first aspect of the invention, a method for providing advertisements is disclosed. The method comprises the step of providing to a device of a user, an advertisement bundle, the advertisement bundle having a runtime and comprising at least one advertisement configured to be played on the device. The method further comprises the steps of detecting that the advertisement bundle has been played to an end of the runtime; computing a reward value based on the advertisement bundle; and automatically transmitting to a subscription server, the reward value and a subscription account number, such that the reward value can be utilized by the subscription server to offset an outstanding subscription payment associated with the subscription account number.

Preferably, the method further comprises the step of receiving from the subscription server or a payment gateway, a confirmation that the outstanding subscription payment has been offset with the reward value.

Preferably, the method further comprises the step of providing to the device, the confirmation that the outstanding subscription payment has been offset with the reward value, and a balance of the outstanding subscription payment subsequent to the offset.

Preferably, the reward value is computed prior to the advertisement bundle being played on the device, and the reward value and the balance of the outstanding subscription payment subsequent to the offset is shown to the user to incentivize the user to watch the advertisement bundle.

Preferably, the method further comprises the steps of providing another advertisement bundle to the device, detecting that the another advertisement bundle has been played to the end of the runtime, and computing another reward value based on the another advertisement bundle, wherein the another reward value is automatically transferred to the subscription server with the reward value and the subscription account number, such that both the reward value and the another reward value can be utilized by the subscription server to offset the outstanding payment associated with the subscription account number.

Preferably, the subscription account number is associated with the user.

Preferably, the subscription account number is associated with another user.

Preferably, the method further comprises the steps of applying user specified filters to assemble the advertisement bundle and the another advertisement bundle; and applying forecasting artificial intelligence to assemble subsequent advertisement bundles.

Preferably, the method further comprises the step of using biometrics authentication techniques during registration of accounts to detect duplicate accounts.

Preferably, the method further comprises the step of using biometrics authentication techniques to detect the user at multiple checkpoints during the runtime of the advertisement bundle before computing the reward value based on the advertisement bundle.

Preferably, the biometrics authentication techniques include facial recognition technology.

Preferably, the method further comprises the step of restricting a number of advertisement bundles being provided to the device over a time period.

Preferably, the method further comprises the steps of integrating an ad-challenge into the at least one advertisement of the advertisement bundle; displaying the ad-challenge on the device while temporarily suspending the playing of the at least one advertisement; and receiving user interaction which completes the ad-challenge and causes the at least one advertisement to resume playing on the device.

Preferably, the method further comprises the step of displaying on the device, elements of a product during the ad-challenge or upon the completion of the ad-challenge.

Preferably, the method further comprises the steps of obtaining emotional analytics data of the user during the runtime of the advertisement bundle and during the user interaction using biometrics; tracking a response time of the user during the user interaction; and applying the emotional analytics data of the user and the response time of the user to a self-adapting algorithm for the customization of a new advertisement bundle and a new ad-challenge.

Preferably, the user has a plurality of subscription accounts across different subscription providers. According to a second aspect of the invention, a system is described, the system comprising at least one server configured to perform any one of the above described methods.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments, by way of example only, and to explain various principles and advantages in accordance with a present embodiment.

FIG. 1 depicts a system for providing advertisements, in accordance with embodiments of the invention.

FIG. 2 depicts a flowchart which depicts a method for providing advertisements, in accordance with embodiments of the invention.

FIG. 3 depicts a flow diagram of artificial intelligence engine being used to customize a new advertisement bundle and ad-challenges for a user, in accordance with embodiments of the invention.

Skilled artisans will appreciate that elements in the figures are illustrated for simplicity and clarity and have not necessarily been depicted to scale. For example, the dimensions of some of the elements in the block diagrams or steps in the flowcharts may be exaggerated in respect to other elements to help improve understanding of the present embodiment.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

It is the intent of certain embodiments to disclose a method of providing to a device of a user, an advertisement bundle, the advertisement bundle having a runtime and comprising at least one advertisement configured to be played on the device. The method further comprises the steps of detecting that the advertisement bundle has been played to an end of the runtime; and then computing a reward value based on the advertisement bundle. The method further comprises the step of automatically transmitting to a subscription server, the reward value and a subscription account number, such that the reward value can be utilized by the subscription server to offset an outstanding subscription payment associated with the subscription account number.

A confirmation that the outstanding subscription payment has been offset with the reward value can be received from the subscription server or an intermediary such as a payment gateway. The confirmation that the outstanding subscription payment has been offset with the reward value, and a balance of the outstanding subscription payment subsequent to the offset can then be provided to the device.

As a “reward” for watching the advertisement bundles, the user gets a reduction of his/her subscription payment to subscription services (for example, video on demand services, audio streaming services, telecommunication services, utility services etc.), as the reward value of the advertisement bundles are offset against the outstanding subscription payment. This creates an incentive for the users to watch advertisement bundles. It is important to highlight that the reward value of the advertisement bundle does not function as a direct “monetary reward” for the user, in that the reward value can only be, and is automatically slated to be, used to offset subscription payments. The reason for this restriction is to prevent or mitigate any abuse of the system i.e., users watching advertisement bundles excessively to make money. The restriction acts as a natural cap on the benefits the user can reap from the system. As the rewards for watching advertisement bundles are confined to only offsetting subscription payments, the user does not get rewarded more than what the user has subscribed. This advantageously discourages excessive watching of the advertisement bundles as there is a limit to the rewards the user can attain. Further, this encourages regular and consistent watching of the advertisement bundles (to offset their monthly subscription payments), as opposed to binge watching.

Though the reward value is confined to only offsetting subscription payments, the subscription account number does not need to be associated with the user. For example, a user can choose to select the subscription account number associated with another user's (who happens to be a friend or family member) for the offset to be applied.

In embodiments, the method further comprises the steps of integrating an ad-challenge into the at least one advertisement; displaying the ad-challenge while temporarily suspending the playing of the at least one advertisement; and receiving user interaction which completes the ad-challenge and causes the at least one advertisement to resume playing on the device. In embodiments, the method further comprises the step of displaying elements of a product during the ad-challenge or upon the completion of the ad-challenge.

The ad-challenges advantageously keep the users engaged while watching the advertisements in the advertisement bundle. This results in a higher engagement factor by the user, which may lead to a higher click-through rate (i.e., user having clicked on a link to the vendor website) and conversion rate (user having purchased an item on the vendor website), and improving the effectiveness of the advertisements. The ad-challenges are also aimed at enhancing a product brand during the screening of the advertisement.

In certain embodiments, the method further comprises the steps of obtaining emotional analytics data of the user during the runtime and during the user interaction using biometrics; tracking a response time of the user during the user interaction; and applying the emotional analytics data of the user and the response time of the user to a self-adapting algorithm for the customization of future advertisement bundles and ad-challenges. Thus, another object of the invention is met as emotional analytics data (e.g., facial analytics data gathered from the user watching the advertisements and interacting with the ad-challenges) and the response time of the user (when interacting with the ad-challenges), can be fed into the self-adapting algorithm to learn and train from the data so as to provide guidance as to what would make an effective advertisement bundle or ad-challenge for that particular user. Therefore, future advertisement bundles and ad-challenges can be customized or tailored specifically to that user. For example, the speed of the ad-challenge can be tuned to the user's age i.e., the speed of the ad-challenge can be faster for a youth while the speed of the ad-challenge can be slower for an adult. In doing so, granularity of target audience is achieved which makes for more effective advertising, as opposed to advertising for the masses which is the typical case.

Embodiments of the present invention will be described, by way of example only, with reference to the drawings. Like reference numerals and characters in the drawings refer to like elements or equivalents.

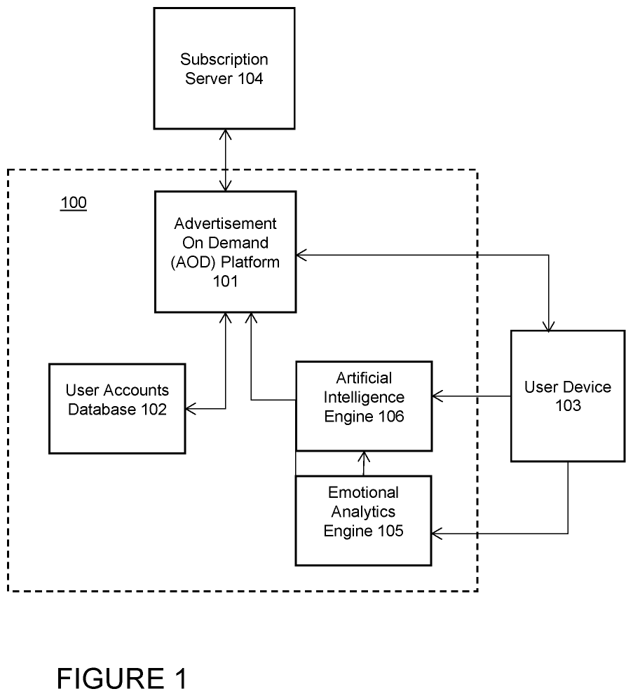

FIG. 1 shows a system 100 in accordance with certain embodiments. System 100 can comprise Advertisement On Demand (AOD) Platform 101 and User Accounts Database 102. AOD platform 101 can be any server, computer, or a group of servers or a group of computers or the like, and User Accounts Database 102 can be any database or group of databases. AOD platform 101 can be configured to provide advertisement bundles to user device 103 via any wired connection or any wireless connection known in the art. For example, AOD platform 101 can be configured to render a web user interface or mobile application interface with the advertisement bundles, which can be accessible or downloaded or streamed by user device 103. When the advertisement bundles have been downloaded to user device 103, the advertisement bundles can be watched on user device 103 without any Wi-Fi, wireless or Internet availability. When connection is reestablished to AOD platform 101, information in user device 103 is then transferred from user device 103 to AOD platform 101, emotional analytics engine 105 and artificial intelligence engine 106.

An advertisement bundle can comprise a single advertisement, or a plurality of advertisements arranged in series. An advertisement bundle can be seen as an assortment of advertisements worth some value based on the type of the advertisements and the number of advertisements in the advertisement bundle. The advertisements in the advertisement bundle can be varied and do not need to subscribe to any particular category. The advertisements in the advertisement bundle can be a random assortment or automatically curated by big data driven algorithms that profiles or forecast users' preferences or a mix based on an automated weightage function. The advertisements can span across advertisements for products; services; TV and movie trailers; and the like.

The advertisement bundles can be obtained from advertisers or advertisement agencies, advertising aggregators (e.g., Google AdSense), or directly from the brand owners (e.g., Nike, Huawei, Zara), or can be independently assembled based on the viewing or purchase history of the user. The advertisement bundles can also be assembled based on the personal data of the user. For example, if the birthday of the user is approaching, the advertisements arranged in the advertisement bundle can be related to birthday parties and birthday cakes. Thus the advertisement bundle provided to the user is both timely and relevant. In addition, friends and family may also celebrate a user's birthday by linking their rewards towards a subscription account number of the user.

An advertisement bundle can have a runtime, that is, a duration in which the advertisement bundle is played from the start to the end. Each advertisement in the advertisement bundle can also have a runtime. The runtime of the advertisement bundle can be the cumulative runtimes of the advertisements in the advertisement bundle, including any transition time (time for transitioning from a preceding advertisement to the next). The runtime of an advertisement bundle can, for example, range between one minute to 10 minutes.

In embodiments, AOD platform 101 can push and recommend advertisement bundles to the user. The manner in which the advertisement bundles are pushed and recommended to the user can be via forecasting artificial intelligence, or by historical data and purchase history of the user. Alternatively, AOD platform 101 can provide filtering functionalities in which the user can indicate preferences on the type of advertisements the user would like to watch. In these embodiments, AOD platform 101 can assemble the advertisement bundle on the fly and based upon the user's specified filters. Another functionality disclosed is to allow for user indication of product preference for a period of time which will result in a higher weightage placing products of interest into the mix of advertisements within artificial intelligence (AI) driven and/or curated advertisement bundles.

However, preferably, the user specified filters are only applied for a short and predetermined duration of time. Upon the expiry of the duration of time, the advertisement bundles being pushed or recommended to the user revert back to one that is determined by forecasting artificial intelligence. For example, the advertisements in the first advertisement bundle provided to the user can be assembled by applying user specified filters, and the advertisements in any subsequent advertisement bundles provided to the user can be assembled by applying forecasting artificial intelligence.

The reason for this restriction is to expose the user to a larger variety of products and services, and not be pigeonholed to any specific product of service categories. For example, a user is interested in a new pair of sneakers. Higher weightage will be put onto sneaker advisements for a short duration of time before AOD platform 101 reverts back to pushing and recommending advertisement bundles based on forecasting artificial intelligence. In embodiments, the advertisement bundles can also be categorized according to themes like “Health and Beauty”, “Finance and Investment”, “Design and Fashion”. The user may also search for preferred advertisement bundles by searching and filtering based on the theme.

Each user can have a unique user ID stored in User Accounts Database 102. Each user_ID can be associated with one or more subscription account numbers with multiple subscription providers, and these associations can be stored in User Accounts Database 102. The subscription account numbers can be pre-entered by the user, for example, during user registration. Further, User Accounts Database 102 can store linkages between different user_IDs to indicate the relationship between the users. For example, if the users are family members or friends. Such linkages can then be applied when a user chooses to apply the reward of watching an advertisement bundle to a subscription account number of another user or provide the receiving user the option of specifying ratios of the received rewards amongst his/her subscriptions.

In embodiments, AOD platform 101 can be configured to detect that the advertisement bundle has been played to the end of its runtime on user device 103. In embodiments, AOD platform 101 can be configured to compute the reward value of the advertisement bundle which has been played to the end of its runtime on user device 103. In embodiments, each individual advertisement in the advertisement bundle can have a reward value, and therefore the reward value of the advertisement bundle can be the summation of the reward values of each of the advertisements in the advertisement bundle. In embodiments, the reward value of the advertisement bundles is variable and not displayed to the user. The reasons for this is to spark the user's curiosity by not explicitly telling the user what the reward value is prior to the viewing of the advertisement bundle by the user, or to provide a pleasant surprise for the user. If the user knows what the reward value is prior to viewing, it becomes more of a monetary goal as opposed to genuine product interest or entertainment value.

In embodiments, the reward value of the advertisement bundles can be computed and categorized and displayed to the user, prior to the user watching the advertisement bundles. The balance of the outstanding subscription payment subsequent to the offset (i.e., the balance of the outstanding subscription payment that would result if the user watched the advertisement bundle) can also be displayed to the user. Quantifying the benefit of watching the advertisement bundles in such a manner would entice or incentivize the user to watch the advertisement bundles. Some advertisement bundles can also have a “floating value” to reflect the dynamic value dependent on the type of advertisement and on the number of advertisements within the advertisement bundle.

In embodiments, AOD platform 101 can be configured to obtain a subscription account number. In embodiments, this subscription account number can be a default one which the user had pre-selected. In embodiments, AOD platform 101 can be configured to retrieve pre-entered subscription account numbers by the user and prompt the user to select from one of them.

In embodiments, AOD platform 101 can be configured to automatically transmit to subscription server 104, the subscription account number and the reward value, the subscription server 104 being associated with the subscription account number. By “automatic”, the user is unable to specify the manner in which the reward value can be redeemed, and the reward value can only be applied to subscription payments. In embodiments, the reward value is immediately transmitted to subscription server 104. In embodiments, the reward value is not immediately transmitted to subscription server 104, and can be accrued over a period of time in AOD platform 101. The accrued reward value can then be transmitted from AOD platform 101 to subscription server 104 in a periodic manner (e.g., monthly).

AOD platform 101 can also utilize block-chain technology to transmit the reward value to subscription server 104. Though FIG. 1 only shows one subscription server 104, one skilled in the art would appreciate that this is for illustration purposes only, and that a user can have multiple subscriptions across different and various subscription platforms.

Subscription server 104 can utilize the reward value to offset an outstanding subscription payment associated with the subscription account number (for example, the user's monthly subscription to video on demand services, audio streaming services, telecommunication services, utility services etc.). The advertisement revenue share would have already been predefined between the parties which allows subscription server 104 to perform the offset. The offset can either be a partial offset or a complete offset. If the reward value exceeds a current's month outstanding subscription payment, the “excess” reward value can be “rolled-over” and utilized to offset the next month's outstanding subscription payment. In embodiments, there can be a predetermined limit to which the excess reward value can be rolled-over. For example, the excess reward value can only be “rolled-over” for up to three months. Any excess reward value will then be forfeited. In embodiments, there is no monetary refund or returns of the rolled over amounts if a user cancels the subscription account. This is to prevent abuse by users cancelling the subscription account and redeeming the rolled-over amounts for money.

In embodiments, AOD platform 101 can be configured to receive from subscription server 104, a confirmation that the outstanding subscription payment has been offset with the reward value. In embodiments, the transaction can be via a payment gateway, and in that scenario, AOD platform 101 can then receive the confirmation that the outstanding subscription payment has been offset with the reward value from the payment gateway.

In embodiments, AOD platform 101 can be configured to provide to the user, by displaying on an interface on user device 103, the confirmation that the outstanding subscription payment has been offset with the reward value, and a balance of the outstanding subscription payment subsequent to the offset.

Therefore, as a reward for watching the advertisement bundles, the user gets a reduction of his/her subscription payment to subscription services. This creates an incentive for the users to watch the advertisement bundles. Also, as the reward value is automatically transmitted to the subscription server 104 to perform the offset of the subscription payment, the user is unable to utilize the reward values for any other purpose. This is important as it helps to avoid users abusing the system by watching advertisement bundles excessively just to make money. The restriction also acts as a natural cap on the benefits the user can reap from the system. As the rewards for watching advertisement bundles are confined to only offsetting subscription payments, the user does not get rewarded more than what the user has subscribed. This advantageously discourages excessive watching of the advertisement bundles as there is a limit to the rewards the user can attain. Further, this encourages regular and consistent watching of the advertisement bundles as opposed to binge watching.

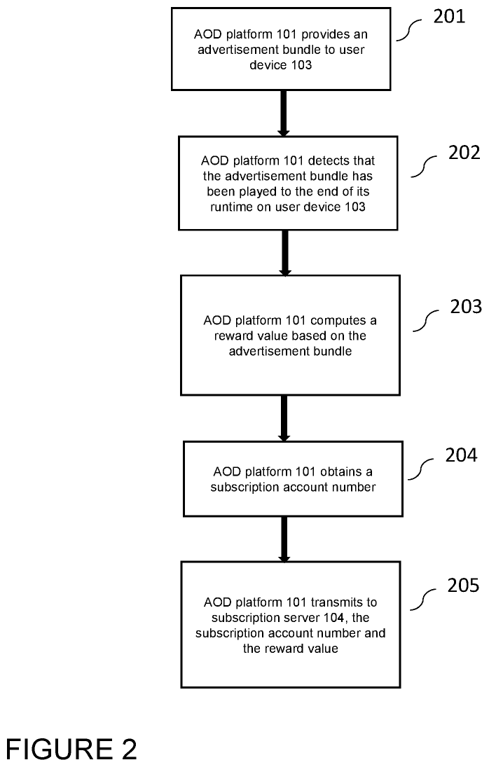

FIG. 2 is a flowchart which depicts a method for providing advertisements, in accordance with certain embodiments. In step 201 of FIG. 2, AOD platform 101 provides an advertisement bundle to user device 103. The advertisement bundle has a runtime and comprises at least one advertisement.

In step 202 of FIG. 2, AOD platform 101 detects that the advertisement bundle has been played to the end of its runtime on user device 103.

In step 203 of FIG. 2, AOD platform 101 computes a reward value based on the advertisement bundle.

In step 204 of FIG. 2, AOD platform 101 obtains a subscription account number. This subscription account number can be a default one which the user had pre-selected. Alternatively, AOD platform 101 can be configured to retrieve pre-entered subscription account numbers by the user and prompt the user to select from one of them. Alternatively, the user can specify the subscription account number that is associated to another user who happens to be a family member or friend so that the offsetting of the outstanding subscription payment using the reward value can function as a gift or present.

In step 205 of FIG. 2, AOD platform 101 automatically transmits to subscription server 104, the subscription account number and the reward value. Subscription server 104 can utilize the reward value to offset an outstanding subscription payment associated with the subscription account number. In embodiments, the reward value is immediately transmitted to subscription server 104. In embodiments, the reward value is not immediately transmitted to subscription server 104, but can be accrued over a period of time in AOD platform 101. The accrued reward value can then be transmitted from AOD platform 101 to subscription server 104 in a periodic manner (e.g., monthly).

AOD platform 101 can then receive from subscription server 104 a confirmation that the outstanding subscription payment has been offset with the reward value. Alternatively, the transaction can be via a payment gateway. And in that scenario, AOD platform 101 can then receive the confirmation that the outstanding subscription payment has been offset with the reward value from the payment gateway.

AOD platform 101 provides to user device 103, the confirmation that the outstanding subscription payment has been offset with the reward value, and a balance of the outstanding subscription payment subsequent to the offset. This confirmation can act an “effort indicator” of sorts to spur the user to continue to watch more advertisement bundles.

In embodiments, AOD platform 101 can implement a restriction on the number of advertisement bundles a user is allowed to view over a certain time period (e.g., 10 advertisement bundles within a 24 hour period).

In embodiments, an advertisement bundle can comprise advertisements integrated with one or more ad-challenges. The ad-challenge can be a game or task or puzzle which can provide elements of communication, educational and entertainment as part of a total advertisement experience. An example of an ad-challenge can be a jig saw puzzle. The ad-challenge can fall either under a cognitive domain (table 1), an affective domain (table 2) or a psychomotor domain (table 3) or hybrids of the 3 categories.

TABLE 1
Ad challenges in the Cognitive Domain

| Domain | Ad-challenge Type | Monitor Parameters |
|---|---|---|
| Recall | Recall information, facts, dates, places | Measure: |
| | Ad-challenge Type: arrange, order, | No of questions right |
| | recognise, duplicate, related, names | Response time |
| Understand | Understand information, meaning, infer | Get the sequence or |
| | Ad-challenge Type: locate, recognise, | response right |
| | identify, indicate, matching left to right | Parameters: |
| Apply | Use information, solve problems in the | Time |
| | right sequence | Colour |
| | Game Type: solve, practice, operate | Response rate |
| Analyse | See patterns, organization of parts, | Text type |
| | recognition of hidden meanings | Size |
| | Ad-challenge Type: Examine, compare, | Difficulty |
| | calculate | Language |
| Synthesize | Use old ideas to create new ones, Predict | Tone |
| | Ad-challenge Type: arrange, assemble, | Music |
| | construct | etc |

TABLE 2
Ad challenges in the Affective Domain

| Domain | Ad-challenge Type | Monitor Parameters |
|---|---|---|
| Receive | Willing to receive information | Measure: |
| | Ad-challenge Type: ask, listen, take part | No of questions right |
| Response | Take part | Response time |
| | Ad-challenge Type: contribute, perform | Get the sequence or |
| Value | Incorporate information | response right |
| | Ad-challenge Type: challenge, criticize, | Parameters: |
| | debate | Time |
| Organize | Make new information as part of | Colour |
| | habit/practice | Response rate |
| | Ad-challenge Type: Develop, modify, | Text type |
| | formulate | Size |
| | | Difficulty |
| | | Language |
| | | Tone |
| | | Music |
| | | etc |

TABLE 3
Ad challenges in the Psychomotor Domain

| Domain | Ad-challenge Type | Monitor Parameters |
|---|---|---|
| Imitation | Imitate action | Measure: |
| | Ad-challenge Type: Copy, follow, | No of questions right |
| | replicate | Response time |
| Manipulation | Repeat based on memory or | Get the sequence or |
| | instruction | response right |
| | Ad-challenge Type: Re-create, | Parameters: |
| | perform | Time |
| Precision | Repeat without instruction | Colour |
| | Ad-challenge Type: Complete, | Response rate |
| | control, association | Text type |
| Articulation | Apply information to another | Size |
| | situation | Difficulty |
| | Ad-challenge Type: Integrate, | Language |
| | formulate, solve | Tone |
| | | Music |
| | | etc |

An ad-challenge can also be classified under one of the following categories: (1) Direct instruction (e.g., Short presentation, Didactic question, Demonstration); (2) Interactive Instruction (e.g., Brainstorming, Discussion/Debates); (3) Experiential (e.g., Role play, Skill Practice, Conduct Experiment); (4) Indirect instruction (e.g., Problem solving, Case studies, Concept formation (e.g., exploration), Reflection) and (5) Independent Study (e.g., projects).

Table 4 illustrates exemplary ad-challenge formats.

TABLE 4
Ad-challenge formats

| | |
|---|---|
| Ad-challenges | In-games Banners, billboards as |
| | background e.g., sport stadium banner |
| | replaced with publisher banners and |
| | placed in a way that's similar to real life |
| | ads placement and appear as part of the |
| | overall flow of the game/challenge with |
| | end of challenge quiz. |
| | Cooking recipe using actual product in |
| | 60 sec (for example, parametric time |
| | frame as part of varying time based on |
| | user predicted response). |
| Contextual Types | A publisher product is designed into the |
| | game play or challenge, as loot, target, |
| | main actor, coin, reward, e.g. Using |
| | Augmented Reality to integrate a brand |
| | of car dash board (BMW or Honda or |
| | etc.) in a simulated scene or environment |
| | or vice-versa if the scene is the objective |
| | of ad (for example as a tourist attraction |
| | location). |
| | Magic Eye art to discover hidden ad |
| | banner within a certain time. |
| Role Play Ads | You play a specific role (your avatar) in |
| | the game. e.g. You are the pizza maker |
| | and taking orders, making, baking and |
| | serving customers |
| | Racing e.g. car is animated according to |
| | real car dimensions and brand specific |
| | designs |
| Problem Solving Ads | Solve a puzzle, e.g. arrange a puzzle in |
| | the order of 1 to 10 level of complexity |
| | under 60 sec |
| | Memory e.g. pick 2 similar products |
| | from closed tile under 60 sec |
| Skill Practice Ads | Follow the steps e.g. how to use |
| | PowerPoint for a specific task (create |
| | animation) or series of tasks in in an |
| | allotted time, say 60 sec |
| | How to use a certain function in an |
| | apps/software/computer to solve a |
| | problem |
| Brain Storming Ads | Self-discovery on how you may be |
| | infected with malaria e.g., using a list of |
| | possible causes |

The ad-challenge can be integrated at any point during the runtime of an advertisement. For example, the ad-challenge can be embedded at the midpoint during the runtime of the advertisement (for example, at the 1 minute mark when the runtime of the advertisement is 2 minutes). When the advertisement bundle is played on user device 103 to the 1 minute mark, the ad-challenge automatically activates and is displayed on user device 103. At this juncture, the playing of the advertisements of the advertisement bundle on user device 103 will be temporarily suspended or halted. Only when the ad-challenge is completed, will the playing of the advertisements in the advertisement bundle resume.

The ad-challenge requires user interaction before it can be completed. User interaction refers to that some cognitive input is required from the user in order to complete the challenge. For example, if the ad-challenge is a jigsaw puzzle, it would require the user to rearrange the jumbled puzzle pieces to solve the jigsaw puzzle Upon completion of the ad-challenge, the ad-challenge will no longer be displayed, and the advertisement will then resume playing (e.g., from the 1 minute mark). In embodiments, elements of a product can also be displayed during the ad-challenge or upon the completion of the ad-challenge. The ad-challenge can also be relevant to the advertisement to which it is integrated. For example, if the advertisement is related to a company selling sports shoes, upon completion of the integrated ad-challenge, the assembled jig saw puzzle could show a picture of a sports shoe product. This is beneficial as the ad-challenge reinforces to the user the product being advertised. As a secondary benefit, the ad-challenge can also be used to support health monitoring analytics such as memory quality and onset of dementia in predictive analysis as well as to help spread public message or campaign such as recycling. The ad-challenges can be a random assortment or automatically curated by big data driven algorithms that profiles or forecast users' preferences or a mix based on an automated weightage function.

The purpose of the ad-challenge is to keep the user engaged while watching the advertisement bundle. The ad-challenge is meant to solicit some intelligible response from the user and to spark some cognitive thinking on the user's part. It is contrasted from a simple “click this” button as the objective of the ad-challenge is to keep the user entertained while watching the advertisements. Another benefit of the ad-challenge is that it ensures that the user is actually paying attention and watching the advertisements. As the activation of the ad-challenge suspends the playing of the advertisement bundle, the user has to complete the ad-challenge before the advertisement bundle can be played to the end of its runtime and for the user to be entitled to the reward value of the advertisement bundle. Ad-challenges can also be parametrically designed so that the cognitive, affective and psychomotor aspect of users are better targeted.

In embodiments, the advertisement bundle can comprise links to a vendor site (e.g., a retailer shopping website). The links are displayed during the runtime of the advertisement bundle. The links can be integrated into the advertisements in the advertisement bundle. In embodiments, AOD platform 101 can be configured to detect when a click-through event has occurred (i.e., the user has clicked on the link and has been directed to the vendor site). In embodiments, AOD platform 101 can also receive a purchase notification from the vendor site server. A purchase notification is sent by the vendor site server when a product/service in the vendor site has been purchased by a user as a result of the click-through event. When that occurs, the vendor site can also provide AOD platform 101 with a commission.

Shown in FIG. 1 is emotional analytics engine 105. Emotional analytics engine 105 can collect and store emotional analytics data. Emotional analytics data can include facial recognition data and brain activity data. Emotional analytics engine 105 can be configured to employ biometrics such as facial recognition technology (e.g., via video input from the user's camera) to ascertain the engagement level of the user when the user is watching the advertisements. For example, if the user has ignored or not watched the advertisement, or if the user has only glanced at the advertisement, or if the user has watched the advertisement intently. In another example, pupil dilation can also indicate certain aspects of emotional responses.

Emotional analytics engine 105 can also employ biometrics authentication techniques, and cross-reference a database, when users are registering accounts, to detect duplicate accounts, and ensure that each account belongs to a unique individual. This is to prevent someone from creating multiple accounts using different email accounts or multiple mobile phone numbers, and addresses the problem of users creating fictitious identities and accounts. Examples of biometrics authentication techniques include facial recognition technology, fingerprint recognition technology, DNA recognition technology, brain wave pattern recognition technology and voice pattern recognition technology.

Emotional analytics engine 105 can also employ facial recognition technology to verify whether the user has watched the advertisement properly. A common problem is that a user can simply step away from the computer while the advertisement bundle is being played, and dishonestly accepting the reward (i.e., offsetting of an outstanding subscription payment with the reward value) even when the user had not, viewed the advertisement bundle in its entirety, or the majority of the advertisements in the advertisement bundle. Emotional analytics engine 105 can use facial recognition technology to detect the user's face at various checkpoints in the advertisement bundle (e.g., at the beginning of the first advertisement, the transition between advertisements, and at the end of the last advertisement). A threshold could be assigned to the checkpoints. If the user's face goes undetected for a certain number of checkpoints, AOD platform 101 would deem that the advertising bundle has not been properly viewed. The facial recognition function can be transparent to the user. Further, at each checkpoint, if the user's face is not detected, AOD platform 101 can display a prompt, reminding the user to watch the advertisement bundle.

Shown in FIG. 1 is artificial intelligence engine 106. Artificial intelligence engine 106 can employ a self-adapting algorithm. Artificial intelligence engine 106 can receive emotional analytics data from emotional analytics engine 105. From the emotional analytics data, artificial intelligence engine 106 can determine the emotional state of the user when the user is watching the advertisements. For example, if the user is happy, sad, scared, surprised, confused etc. The response time of a user (i.e., the speed in which the user responds to an ad-challenge) can also be fed to artificial intelligence engine 106.

Artificial intelligence engine 106 can utilize the user response time and the emotional analytics data to effectively predict the type of advertisements that will resonate with the user. For example, artificial intelligence engine 106 can provide guidance to AOD platform 101 on which advertisements should be part of the advertisement bundle being pushed to the user. The level of detail can also include specific aspects of the advertisements, which color combinations, language complexity, object types, that will provide the best chance of connecting the user. Artificial intelligence engine 106 can also provide user-specific modifications to the ad-challenges to suit user's age, favorite colors, response time, complexity levels etc. Therefore, subsequent advertisement bundles and its integrated ad-challenges, pushed by AOD platform 101 to user device 103 can be tailored specifically to the user.

Artificial intelligence engine 106 can also predict the “viral-ness” or effectiveness of the advertisements. Artificial intelligence engine 106 can apply regression analysis to understand the effectiveness of ad-challenges and newly produced advertisements in engaging users and ultimately conversion (i.e., user does a click-through and purchase an item on the vendor website). It helps in the sensitivity analysis where the various independent variables are chosen and applied in the calculation to see how it impact the effectiveness of that particular advertisement and ad-challenge. The independent variable can be the user's response time to completing the ad-challenge or the ease in which the user completes the ad-challenge while the dependent variable is the engagement index. The engagement index is based on the peak number of followers plus the time period of interest.

To predict the “viral-ness” or effectiveness of the advertisements, an algorithm can be employed with the following three differential equations:-

E′[t]=−beta E[t]U[t] (1)
[Comment: fraction of population that can become users]

U′[t] =beta E[t] U[t]−kapa U[t]+D(t=infinity) (2)
[Comment: fraction that actually became engaged users]

B′[t]==k U[t]−D(t=infinity) (3)
[Comment: the rate of users that get bored]
   where E(t) is the number of potential users at time t; U(t) is the number of users that found it interesting at time t; B(t) is the number of users that got bored at time t and D(t) is the number of diehard users at time t which can be a constant too.

To determine the “viral-ness”, artificial intelligence engine 106 must first obtain emotional analytics data from emotional analytics engine 105 and the ad-challenge response time. Other bodily responses such as visual, audio or oratorical, brain and nerve signals, skin temperature, can also be fed into artificial intelligence engine 106 provided there are available sensors or devices to detect such responses. Data collected from these responses for a particular advertisement will be correlated and categorized. This data will be used partially or in full to create a transfer function or a multi-variable function which would be used to predict the outcome of a new advertisement or help provide guidance to what would make an effective advertisement. This data will adjust and evolve which each turn of data collection to refine the correlation categorically. Different aspects of data, user demographics, responses, used for analytics in conjunction with the self-learning/adapting algorithm to create predictions of objectives of advertisements (viralness, engagement factor, desired user response and etc).

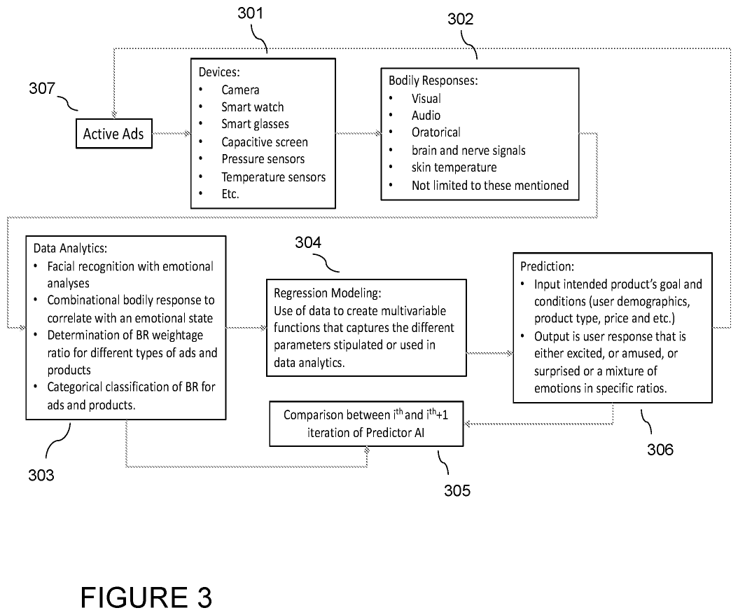

FIG. 3 depicts a flow diagram of how artificial intelligence engine 106 can be used to customize a new advertisement bundle with new ad-challenges for a user. In 301, devices such as cameras, smart watches and sensors are used to obtain user response data. In 302, the user response data can be bodily responses in the realm of visual responses, audio responses and oratorical responses. In 303, the user response data is fed into artificial intelligence engine 106 to perform data analytics. In 304, artificial intelligence engine 106 performs regression modelling to create multivariable functions that captures the different parameters stipulated or used in data analytics. In 305, artificial intelligence engine 106 compares the i^{th} and i^{th}+1 iterations. In 306, the intended product's goals and conditions (user demographics, product type, price) are input and artificial intelligence engine 106 outputs a predicted user response which is a function of emotions (e.g., excited/amused/surprised) in specific ratios. In 307, AOD platform 101 uses the predicted user response to customize a new advertisement bundle or a new ad-challenge for the user. Therefore, future advertisement bundles and ad-challenges can be customized or tailored specifically to that user. For example, the speed of the ad-challenge can be tuned to the user's age i.e., the speed of the ad-challenge can be faster for a youth while the speed of the ad-challenge can be slower for an adult. In doing so, granularity of target audience is achieved which makes for more effective advertising.

Unless specifically stated otherwise, and as apparent from the following, it will be appreciated that throughout the present specification, discussions utilizing terms such as “receiving”, “identifying”, “initiating”, “tagging”, “transmitting”, “running”, “incrementing”, “determining”, “assigning”, “approving”, “selecting”, “sending”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

In the application, unless specified otherwise, the terms “comprising”, “comprise”, and grammatical variants thereof, intended to represent “open” or “inclusive” language such that they include recited elements but also permit inclusion of additional, non-explicitly recited elements.

It will be apparent that various other modifications and adaptations of the application will be apparent to the person skilled in the art after reading the foregoing disclosure without departing from the spirit and scope of the application and it is intended that all such modifications and adaptations come within the scope of the appended claims.

1. A computer-implemented method comprising the steps of:-
providing to a device of a user, an advertisement bundle, the advertisement bundle having a runtime and comprising more than one advertisement configured to be played serially on the device;
detecting that the advertisement bundle has been played to an end of the runtime;
computing a reward value based on the advertisement bundle; and
automatically transmitting to a subscription server, the reward value and a subscription account number, such that the reward value is directly utilized by the subscription server to offset an outstanding recurring subscription payment associated with the subscription account number; wherein when the reward value exceeds the outstanding recurring subscription payment, the excess reward value can only be rolled-over for a predetermined number of times to be utilized in the subsequent recurring subscription payments.

2. The computer-implemented method of claim 1 further comprising the step of receiving from the subscription server or a payment gateway, a confirmation that the outstanding recurring subscription payment has been offset with the reward value.

3. The computer-implemented method of claim 2 further comprising the step of providing to the device, the confirmation that the outstanding recurring subscription payment has been offset with the reward value, and a balance of the outstanding recurring subscription payment subsequent to the offset.

4. The computer-implemented method of claim 3 wherein the reward value is computed prior to the advertisement bundle being played on the device, and the reward value and the balance of the outstanding recurring subscription payment subsequent to the offset is shown to the user to incentivize the user to watch the advertisement bundle.

5. The computer-implemented method of claim 1 further comprising the steps of:-
providing another advertisement bundle to the device;
detecting that the another advertisement bundle has been played to the end of the runtime; and
computing another reward value based on the another advertisement bundle;
wherein the another reward value is automatically transmitted to the subscription server with the reward value and the subscription account number, such that both the reward value and the another reward value are directly utilized by the subscription server to offset the outstanding recurring subscription payment associated with the subscription account number.

6. The computer-implemented method of claim 1 wherein the subscription account number is associated with the user.

7. The computer-implemented method of claim 1, wherein the subscription account number is associated with another user.

8. The computer-implemented method of claim 5 further comprising the steps of:-
applying user specified filters to assemble the advertisement bundle and the another advertisement bundle; and
applying forecasting artificial intelligence to assemble subsequent advertisement bundles.

9. The computer-implemented method of claim 1 further comprising the step of using biometrics authentication techniques during registration of accounts to detect duplicate accounts.

10. The computer-implemented method of claim 9 further comprising the step of using the biometrics authentication techniques to detect the user at multiple checkpoints during the runtime of the advertisement bundle before computing the reward value based on the advertisement bundle.

11. The computer-implemented method of claim 9 wherein the biometrics authentication techniques include facial recognition technology.

12. The computer-implemented method of claim 1 further comprising the step of restricting a number of advertisement bundles being provided to the device over a time period.

13. The computer-implemented method of claim 1 further comprising the steps of:-
integrating an ad-challenge into the at least one advertisement of the advertisement bundle;
displaying the ad-challenge on the device while temporarily suspending the playing of the at least one advertisement; and
receiving user interaction which completes the ad-challenge and causes the at least one advertisement to resume playing on the device.

14. The computer-implemented method of claim 13 further comprising the step of displaying on the device, elements of a product during the ad-challenge or upon the completion of the ad-challenge.

15. The computer-implemented method of claim 13 further comprising the steps of:-
obtaining emotional analytics data of the user during the runtime of the advertisement bundle and during the user interaction using biometrics;
tracking a response time of the user during the user interaction; and
applying the emotional analytics data of the user and the response time of the user to a self-adapting algorithm for the customization of a new advertisement bundle and a new ad-challenge.

16. The computer-implemented method of claim 1 wherein the user has a plurality of subscription accounts across different subscription providers.

17. A system comprising at least one server configured to perform the method as claimed in claim 1.
